(19) United States
(12) Patent Application Publication
(10) Pub. No.: US 2008/0172355 A1
(43) Pub. Date: Jul. 17, 2008

(54) LOAD SHEDDING IN CONTINUAL QUERY SYSTEMS

(76) Inventors: Bugra Gedik, White Plains, NY (US); Kun-Lung Wu, Yorktown Heights, NY (US); Philip Shi-lung Yu, Chappaqua, NY (US)

Correspondence Address: KEUSEY, TUTUNJIAN & BITETTO, P.C., 20 CROSSWAYS PARK NORTH, SUITE 210, WOODBURY, NY, 11797, US

(21) Appl. No.: 11/622,782

(22) Filed: Jan. 12, 2007

(51) Int. Cl. G06F 7/06

(52) U.S. Cl. 707/2; 707/E17.017

(57) ABSTRACT

A system and method for processing continual queries includes partitioning an entire monitoring area into regions of different size based upon node and query densities, and deciding an amount of information updates to be received from nodes in the regions based upon load conditions in each region. Information updates are received based on the amount of information updates determined for each region.

### GOVERNMENT RIGHTS

This invention was made with Government support under Contract No.: H98230-05-3-0001 awarded by the U.S. Department of Defense. The Government has certain rights in this invention.

### BACKGROUND

1. Technical Field

The present invention relates to performing continual query (CQ) processing in a mobile system, and more particularly to systems and method for receiving information (e.g., position) updates from mobile nodes and executing long running queries, such as, e.g., range queries, that are dependent on mobile node positions.

2. Description of the Related Art

The proliferation of mobile devices and advances in wireless communications are creating an increasing interest in rich, value-added location-based services. These services are expected to form an important part of the future computing environments. A recent example of such services includes the Google Ride Finder service (see e.g., http://labs.google.com/ridefinder), which provides mobile users with the capability to employ continual queries (CQs) to monitor nearby taxi services.

Mobile CQ systems serve as an enabling technology for location monitoring applications. Scalable CQ middleware for location monitoring has been an active area of research, as evidenced by several recent works, such as SINA (see “SINA: Scalable incremental processing of continuous queries in spatio-temporal databases,” by M. F. Mobel, et al., in Proceedings of the ACM SIGMOD International Conference on Management of Data, 2004) and MAI (see “Processing moving queries over moving objects using motion adaptive indexes,” by B. Gedik, et al., in IEEE Transactions on Knowledge and Data Engineering, 18(5):651-G68, 2006). In almost all of these systems, position updates and query re-evaluations are two predominant and costly components of processing location-based CQs, consuming CPU, disk, and wireless network resources.

To produce high-quality query results, the query processor usually demands frequent position updates from mobile nodes. However, receiving and processing frequent updates often causes the query processor to become overloaded. As a result, the update problem in mobile CQ systems has received significant attention from the research community, producing several spatial index structures for efficiently integrating position updates into the system. See e.g., “Indexing the positions of continuously moving objects,” by S. Saltenis and others, in Proceedings of the ACM SIGMOD International Conference on Management of Data, 2000). Although indexes can speed up the processing of position updates, they do not solve the fundamental problem of overload. When overloads happen, the position updates will clog the system buffers and cause updates to be dropped randomly, which is an ineffective way to handle overload.

None of the prior works have addressed the problem of effective update load shedding. Hence, there is a cogent need for developing intelligent update load-shedding techniques for mobile CQ systems. The load shedding algorithms should prevent overloads by reducing the number of position updates received and processed by the query processor, while minimizing the side-effects of degradation on query-result accuracy.

### SUMMARY

A system and method for processing continual queries includes partitioning an entire monitoring area into regions of different size based upon node and query density, and deciding an amount of information updates to be received from nodes in the regions based upon load conditions in each region. Information updates are received based on the amount of information updates determined for each region.

These and other features and advantages will become apparent from the following detailed description of illustrative embodiments thereof, which is to be read in connection with the accompanying drawings.

### BRIEF DESCRIPTION OF DRAWINGS

The disclosure will provide details in the following description of preferred embodiments with reference to the following figures wherein:

FIG. 1 is a diagram showing a system architecture for processing continual queries in accordance with one illustrative embodiment;

FIG. 2 is a block/flow diagram showing a system/method for partitioning monitoring space in accordance with the present principles;

FIG. 3 is a block/flow diagram showing a system/method for setting update throttlers in accordance with the present principles;

FIG. 4 is a block/flow diagram showing a system/method for setting update throttlers which supports fairness constraints in accordance with the present principles;

FIG. 5 is a block/flow diagram showing a system/method for setting and updating a throttle fraction in accordance with the present principles; and

FIG. 6 is a block/flow diagram showing a system/method for processing continual queries in a distributed system in accordance with illustrative embodiments.

### DETAILED DESCRIPTION OF PREFERRED EMBODIMENTS

Present embodiments regulate a number of position updates received and processed by a query server by performing region-aware position update load shedding. This may include partitioning monitored space into regions, preferably uneven regions based on mobile node and query densities; and applying region-specific update load shedding such that the overall load can be handled by the query server, and query result accuracy is maximized. Methods are disclosed to determine, among other things, how the monitoring space is partitioned into a set of regions, how the amount of position updates to be shed is decided for these regions, and how the overall position update budget is dynamically set.

In accordance with the present principles, lightweight load-shedding methods and systems are disclosed for reducing the update load in mobile continual query (CQ) systems. Given an update budget (which is either calculated automatically by the system or specified as a system-level throttle fraction parameter, the present system creates a partitioning of the monitoring space into a set of shedding regions and associates an update throttler with each shedding region, where these update throttlers define the amount of load shedding to be performed for each region in accordance with the overall update budget. Generally, update load shedding decreases the quality of query results. In one embodiment, both the partitioning and the settings of the update throttlers are performed with the objective of minimizing the negative impact of load shedding on the accuracy of query results.

Preferred embodiments include four properties. First, the partitioning scheme employed in accordance with the present principles is region-aware. Contiguous geographical areas that have similar characteristics in terms of densities of mobile nodes and queries are grouped into the same load shedding regions. Second, update throttlers are set based on the following principle: the regions where update load shedding may cut down a large number of updates while reducing the query-result accuracy minimally, are subjected to larger amounts of load shedding.

Third, an adjustable bound on the maximum difference is provided between the update throttlers of different shedding regions, ensuring that all mobile nodes are tracked by the system and may include varying accuracies. This feature extends the applicability of the present embodiments to mobile CQ systems with snapshot and historical query support. Fourth, present embodiments introduce very little overhead and can be employed in conjunction with CQ systems that use update-efficient indexes.

Embodiments of the present invention can take the form of an entirely hardware embodiment, an entirely software embodiment or an embodiment including both hardware and software elements. In a preferred embodiment, the present invention is implemented in software, which includes but is not limited to firmware, resident software, microcode, etc.

Furthermore, the invention can take the form of a computer program product accessible from a computer-usable or computer-readable medium providing program code for use by or in connection with a computer or any instruction execution system. For the purposes of this description, a computer-usable or computer readable medium can be any apparatus that may include, store, communicate, propagate, or transport the program for use by or in connection with the instruction execution system, apparatus, or device. The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code may include at least one processor coupled directly or indirectly to memory elements through a system bus. The memory elements can include local memory employed during actual execution of the program code, bulk storage, and cache memories which provide temporary storage of at least some program code to reduce the number of times code is retrieved from bulk storage during execution. Input/output or I/O devices (including but not limited to keyboards, displays, pointing devices, etc.) may be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

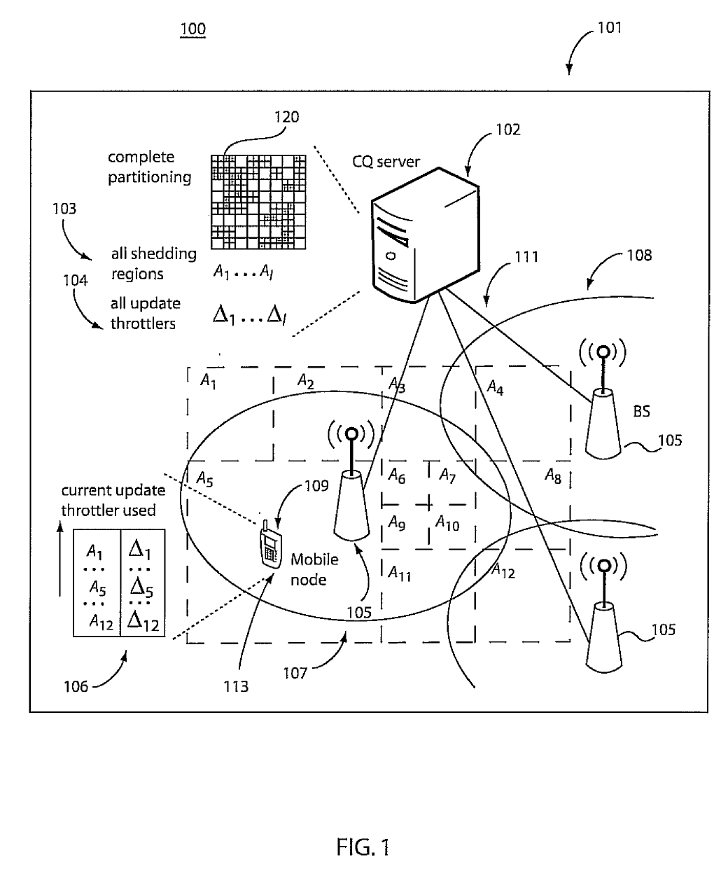

Referring now to the drawings in which like numerals represent the same or similar elements and initially to FIG. 1, a system architecture 101 of a system 100 includes three layers. A first layer is formed by a mobile CQ server 102. The server 102 has three main responsibilities. First, the server 102 sets a throttle fraction z to define a position update budget for the system 100. Second, the server 102 is responsible for calculating shedding regions 103, and associated update throttlers 104 for a given update budget. Third, the server 102 is responsible for reporting to each base station (BS) 105, in a second layer 108, a subset of shedding regions and update throttlers 106, corresponding to a base station's coverage area 107. Note the shedding areas are designated by A and the throttlers are designated by Δ.

The set of base stations 105 that cover the space of interest form the second layer 108. The base stations 105 are preferably connected to the mobile CQ server 102 via a wired or wireless network 111. The base stations 105 provide wireless networking services to mobile nodes 109. The base stations 105 are responsible for broadcasting the subset 106 of load shedding regions and update throttlers corresponding to their coverage area 107 to mobile nodes 109, when the server 102 reports a change in the partitioning or the update throttler values.

In one embodiment, mobile nodes 109 may include sensors distributed throughout a space, which may be monitored in accordance with the present principles. The sensors may be stationary and employed to monitor local conditions and report these conditions to the server 102. The conditions may include weather (temperature, humidity, wind velocity, etc.), traffic, or other conditions. A combination of mobile units and sensors may also be employed.

The base stations 105 are also responsible for sending the shedding regions (A) and update throttlers (Δ) to a mobile node 109 entering into a new base station's coverage area 107 during a hand-off.

The set of mobile nodes 109 form a third layer 113 of the system 100. The mobile nodes 109 are responsible for reporting their positions to the mobile CQ server 102 using, e.g., dead reckoning. However, the inaccuracy threshold used by a mobile node 109 is dependent on the region in which the node 109 resides. As a result, the mobile nodes 109 store a subset 106 of shedding regions and update throttlers corresponding to the coverage area 107 of their current base station 105. As the nodes 109 move from one shedding region (A) to another within their base station's coverage area 107, the mobile nodes use the update throttler (e.g., Δ₅) corresponding to their current shedding region (e.g., A₅) as the inaccuracy threshold. This is performed locally. When the mobile nodes 109 switch base stations 105, the nodes 109 change the subset 106 of shedding regions and update throttlers they store based on the information they receive from the new base station.

In a preferred embodiment, a lightweight, region-aware load-shedding system is provided for preventively reducing the position-update load of a query processor, while maintaining high-quality query results. There are two major types of load shedding techniques for reducing the number of position updates processed by a query processor: server-actuated and source-actuated. In server-actuated load shedding, the position updates are dropped by the CQ server 102 to match the update arrival rate with the server service rate. This has two disadvantages. First, the dropped updates are unnecessarily transferred from the mobile nodes 109 to the CQ server 102, wasting the wireless network bandwidth. Second, the excessive updates still have to be received by the server 102, and thus contribute to the processing load.

On the other hand, the source-actuated approach needs some coordination between the server 102 and the mobile nodes 109, since the load shedding decisions are made by the server 102. With a lightweight process for coordination, the source-actuated approach for load shedding may be preferred although either technique may be employed.

One mechanism that may be employed for actuating the position update reduction on the mobile nodes 109 is motion modeling, also known as dead reckoning. Motion modeling uses approximations for location update prediction. Instead of reporting the position updates each time the node 109 moves, mobile nodes 109 only report the parameters of a model approximating their motion when the model parameters change significantly, which is decided based on an inaccuracy threshold Δ and the last reported model parameters. When the predicted position of a mobile node deviates from its actual position by more than Δ, the new motion parameters are reported, e.g., a position update is sent by the mobile node 109. This inaccuracy threshold Δ is employed in accordance with the present principles as a “control knob” to adjust the number of position updates sent by a mobile node 109.

One motion model employs a piece-wise linear approximation of the mobile node movement (see, e.g., “Updating and querying databases that track mobile units,” by O. Wolfson et al., in Distributed and Parallel Databases, 7(3):257-387, 1999, incorporated herein by reference). Without loss of generality, a linear motion modeling may be adapted for simplifying explanation. Other motion models may also be employed.

A straightforward but naive way of shedding update load is to have all mobile nodes 109 use a single system-controlled inaccuracy threshold (Δ). Let Δ_{<} be the minimum value that the inaccuracy threshold can take, which defines the ideal resolution of position updates. Let Δ_{>} be the maximum value that the inaccuracy threshold can take, which defines the lowest resolution of position updates needed to achieve reasonable query-result accuracy.

The inaccuracy threshold Δ can be set to a value within [Δ_{<},Δ_{>}] to adjust the update expenditure of the system. By increasing Δ from Δ_{<} to Δ_{>}, the number of updates will decrease even though this reduction is not linear. An update reduction factor, denoted as f(Δ), may be used to capture the change in the number of updates with changing Δ. For a given inaccuracy threshold Δε[Δ_{<},Δ_{>}], f(Δ) gives the number of position updates received relative to the case of Δ=Δ_{<}.

One observation made is that different regions (A) exhibit different characteristics in terms of the densities of mobile nodes 109 and queries (from the nodes) and can benefit from differing amounts of load shedding. This observation suggests that a uniform Δ approach is significantly suboptimal.

Let n be the number of mobile nodes 109 and m be the number of queries within a region (A). When n is low and m is high for a region, load shedding should be avoided as much as possible. This is because a small number of nodes that generate few updates are used for answering a large number of queries for this region. This implies that increasing Δ here will significantly impact the overall query accuracy, while bringing only a small reduction in the number of position updates sent to the server.

In contrast, load shedding is very desirable when n is high and m is low for a region. In this case, a large number of nodes that generate many updates are used for answering few queries. This implies that increasing Δ will minimally impact the overall query accuracy, while bringing a large reduction in the number of position updates sent to the server 102. The ratio m/n does not completely characterize the preference of one region over another for increasing the inaccuracy threshold Δ. This is because the overall inaccuracy introduced in the mobile node positions increases linearly with increasing Δ, whereas the amount of update reductions increases non-linearly as Δ increases.

This leads to the region-aware approach in accordance with the present principles to update load shedding. In present embodiments, a geographical area of interest is partitioned into l shedding regions, denoted by Aᵢ, iε[1 . . . l]. Furthermore, an inaccuracy threshold is associated with each shedding region Aᵢ, denoted by Δᵢ. Δᵢ is also referred to as an update throttler of the region Δᵢ. A simple way of determining the shedding regions is to partition the entire geographical space of interest into l regions evenly. However, such even partitioning of the space is unlikely to produce an effective solution, since the level of heterogeneity (in terms of the number of mobile nodes and queries) inside two given equally-sized regions may differ significantly.

A region where further partitioning generates sub-regions of similar characteristics in terms of the densities of mobile nodes and queries does not provide any gain with regard to reducing the number of position updates while minimizing the query-result inaccuracy. Thus, the design of the load shedder should address the following two challenges: (1) How to partition the geographical space of interest into a set of shedding regions effectively? (2) How to set the update throttler for each shedding region to minimize the inaccuracy introduced in query results while meeting our update budget constraint?

In accordance with present principles, a throttle fraction (z) is employed to define the position update budget of the system, denoted by zε[0,1]. For example, z=0.75 means that the number of updates should be reduced by a quarter, compared to the case of using a common Δ=Δ_{<}. The throttle fraction can be calculated automatically by the server 102 in reaction to overload situations by observing the size of the system message queue. Alternatively, when the server 102 is not overloaded but the wireless communication load of receiving updates are putting a heavy burden on the network 111, the throttle fraction can be manually set as a system-level parameter.

The main technical components of a load shedder system 100, in accordance with one illustrative embodiment, encompass three major server-side functionalities: (1) partitioning the geographical space of interest into l shedding regions for a given l, performed by, e.g., a GridReduce algorithm, described hereinafter, (2) determining the update throttler for each of the l shedding regions, performed by, e.g., a GreedyIncrement algorithm, described hereinafter, and (3) setting the throttle fraction z to adjust the system-wide position update budget, performed by, e.g., a ThrotLoop algorithm, described hereinafter. These three algorithms work in cooperation to perform the load shedding. In particular, the ThrotLoop algorithm monitors the performance of the system under the current workload and resource availability to decide the throttle fraction z. Given z computed by ThrotLoop and the number l of shedding regions specified as a system-supplied parameter, the GridReduce algorithm creates a partitioning of the entire geographical space of interest and computes the set of l shedding regions, i.e., Aᵢ, iε[1 . . . l]. Finally, given z, l, and Ails, the GreedyIncrement algorithm determines the update throttlers for the l shedding regions, i.e., Δᵢ, iε[1 . . . l].

One problem is to find a partitioning of Aᵢ, iε[1 . . . l], and an associated set of update throttlers Δᵢ, iε[1 . . . l], such that certain constraints are met (e.g., the update budget is respected) and an objective function is optimized (e.g., inaccuracy in query results is minimized). Formulating the two constraints, let nᵢ denote the number of mobile nodes 109 within shedding region Aᵢ. The following two constraints should hold:

$${\sum }_{i = 1}^{l} {n}_{i} * f ( {Δ}_{i} ) \leq z * n * f ( {Δ}_{<} )$$

$${∀}_{i ∈ [ 1. . l ]} {Δ}_{<} \leq {Δ}_{i} \leq {Δ}_{>}$$

The first constraint, called the update budget constraint, states that the number of updates received under the region-aware load shedding approach should not exceed z (throttle fraction) times the number of updates that would have been received if there were no load shedding applied, i.e., if a uniform inaccuracy threshold of Δ_{<} for all nodes were to be employed. Note that f(Δ_{<})=1. The second constraint defines the domain of update throttlers (Δᵢ's).

An objective function of the problem to be minimized is formulated, that is, to minimize the inaccuracy in query results. For the purpose of this problem formalization, the inaccuracy introduced may be defined by using an update throttler value of Δᵢ for a given region Aᵢ as the number of queries in the region Aᵢ, denoted by mᵢ, times the inaccuracy threshold Δᵢ, that is mᵢ*Δᵢ. When computing mᵢ, queries partially intersecting the shedding region Aᵢ are fractionally counted. The objective function to minimize can be formulated as:

$$Inacc ( \{ {A}_{i} \} , \{ {Δ}_{i} \} ) = {\sum }_{i = 1}^{l} {m}_{i} * {Δ}_{i}$$

Note that mᵢ and nᵢ are functions of the partitioning {Aᵢ}. An extension to this basic problem is included to provide a system-level control over the difference in the inaccuracy thresholds used in different regions. A parameter called the fairness threshold may be introduced, denoted by Δ [symbol] . In the original problem formulation, the shedding regions that do not include any queries (e.g., {Aᵢ: mᵢ=0}) may be overly penalized by setting their update throttlers to the maximum inaccuracy value of Δ_{>}, since the update reduction for those regions does not impact the query results. However, for mobile CQ systems supporting historic and ad-hoc queries, this may be undesirable, thus Δ [symbol] can be used to reduce this effect.

Formally, the following additional constraint on the update throttles is included: ∀_{i,jε[1 , , , l]}|Δ_{∫}−Δ_{∫}|≦Δ

[symbol]

One extreme case of Δ [symbol] =Δ_{>}−Δ_{<} represents the original formulation, whereas the other extreme case of Δ [symbol] =0 represents the uniform Δ scenario.

Consider the partitioning and the setting of update throttlers as separate problems. A heuristic-based partitioning algorithm may be provided for constructing the shedding regions and then an algorithm for setting the update throttlers for a given partitioning of the space may be applied. The goal of the GridReduce algorithm is to partition the geographical space of interest into l shedding regions, such that this partitioning produces lower query-result inaccuracy. For each shedding region Aᵢ generated, the GridReduce algorithm also determines the number of nodes nᵢ and the number of queries mᵢ for that region. This information is later used by GreedyIncrement to set the update throttlers.

The GridReduce algorithm works in two stages and uses a statistics grid 120 as the base data structure to guide its decisions. The statistics grid 120 serves as a uniform, maximum fine-grained partitioning of the space of interest. In a first stage of the algorithm, which follows a bottom-up process, a region hierarchy is created over the statistics grid 120 and the query and mobile node statistics are aggregated for the higher-level regions in this hierarchy. This region hierarchy serves as a template from which a non-uniform partitioning of the space can be constructed. A second stage follows a top-down process and creates the final set of l shedding regions, starting from the highest region in the hierarchy (the whole space). The idea is to selectively pick and drill down on a region using the hierarchy constructed in the first stage. The region to drill down is determined based on the expected gain in the query-result accuracy, called accuracy gain, which is computed using the aggregated region statistics.

The statistics grid 120 is an α×α evenly spaced grid over the geographical space, where α is the number of grid cells on each side of the space. For each grid cell c_{i,j} the statistics grid 120 stores the average number of mobile nodes n_{i,j} and queries m_{i,j} for that grid cell. The only data structure maintained over time by the load shedder system 100 is this grid.

The maintenance of the grid can be performed in a number of ways. For example, if the mobile CQ server 102 uses a grid-based index on mobile node positions the statistics grid 120 can be supported as a part of the grid index. Alternatively, the grid 120 can be explicitly maintained by processing position updates. Note that it takes constant time to process an update for maintaining the grid 120. Moreover, all of the updates need not be processed, since the statistics can easily be approximated using sampling. In an off-line alternative, the average number of mobile nodes 109 can be pre-computed for different times of the day based on historic data, in which case the maintenance cost is close to zero. In all three alternatives, maintenance of the statistics grid 120 is a lightweight operation. The partitioning generated by the GridReduce algorithm using an α×α grid is called an (α,l)-partitioning.

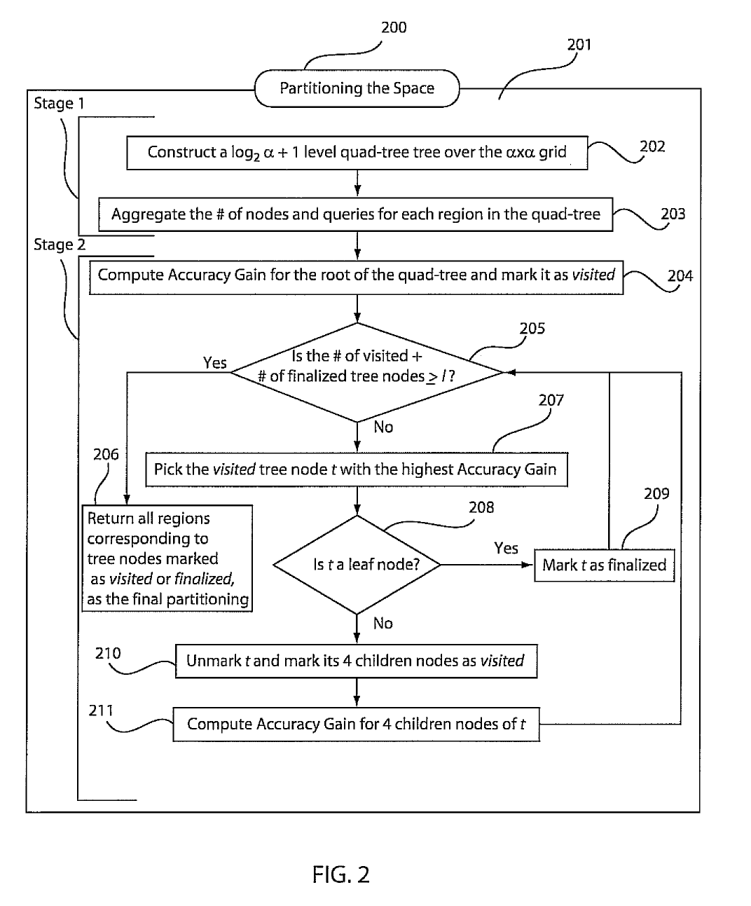

Referring to FIG. 2, a block/flow diagram showing the GridReduce algorithm 200 for partitioning a space 201 is illustratively depicted. In the first stage, a complete quad-tree (e.g., a log₂ α+1 levels) is constructed over a grid (α×α) in block 202. Each tree node corresponds to a different region in the space, where regions get larger closer to a root node which represents the whole space. Each level of the quad-tree is a uniform, non-overlapping partitioning of the entire space. As is known, a quad-tree node includes four children nodes (except for leaf nodes, e.g., at the ends). Other types of trees may also be employed. Through a post-order traversal of the tree, the statistics associated with grid cells are aggregated for each node of the tree in block 203, e.g., the number of mobile nodes and number of queries for each tree node's region are computed. The first stage of the algorithm takes O(α²) time and consumes O(α²) space.

in the second stage, starting with the root node of the tree, i.e., the entire space, compute the accuracy gain for the root and mark the root as visited in block 204. At each step, pick a visited tree node t (initially only the root node) in block 207, and replace the node with its four child nodes in the quad-tree in block 210. This process continues until at least l visited tree nodes are reached as checked in block 205 (corresponding to l shedding regions as finalized in block 206). The crux of the second stage lies in how a region is chosen to further partition during each step. For this purpose, a max-heap of all visited tree nodes is maintained based on their accuracy gains, and at each step the node with the highest accuracy gain is picked in block 207. In block 208, a determination of whether the current node is a leaf node is made. If the current node t is a leaf node, the node t is marked as finalized and the algorithm returns to block 205 for the next node.

If the node t is not a leaf node, node t is unmarked and its 4 children are marked as visited in block 210. Accuracy gain is computed for the four children nodes in block 211 before returned in block 207.

Given a tree node, the accuracy gain is a measure of the expected reduction in the query-result inaccuracy, achieved by partitioning the node's region into 4 sub-regions corresponding to its child nodes. For a tree node t, the accuracy gain V[t] is calculated as follows. Let E[t] be the average result inaccuracy if we only had one shedding region that is t's region. Formally, we have E[t]←min_{Δ}, (m[t]*Δ), s.t. f(Δ)≦z*f(Δ_{<}). Now let Eₚ[t] be the average result inaccuracy if we had 4 shedding regions that correspond to the regions of t's child nodes tᵢ, iε[1 . . . 4]. Formally, we have

$${E}_{p} [ t ] ← {min}_{{Δ}_{i}} {\sum }_{i = 1}^{4} {Δ}_{i} * m [ {t}_{i} ]$$

subject to the constraint

$${\sum }_{i = 1}^{4} n [ {t}_{i} ] * f ( {Δ}_{i} ) \leq z * n [ t ] * f ( {Δ}_{<} ) .$$

Then the difference E[t]−Eₚ[t] gives us the accuracy gain V[t].

The computation of E[t] and Eₚ[t], and thus the accuracy gain V[t], solves the problem of update throttler setting for a fixed l of shedding regions. Computation of E[t] needs to solve for node t with l=1 and computation of Eₚ[t] needs to solve for the 4 child nodes of t with l=4. This general problem can be solved in log-linear time on 1. As a result, the accuracy gain is computed in constant time for a tree node t. The second stage of the GridReduce algorithm takes O(l*logl) time and consumes O(l) space, bringing the combined time complexity to O(1*log 1+α²) and space complexity to O(α²+l).

A goal of the GreedyIncrement algorithm is to find an optimal setting of the update throttlers associated with the l shedding regions produced by the GridReduce algorithm (FIG. 2), so that the inaccuracy in query results is minimized (while respecting the fairness thresholds). First, consider this problem without the fairness threshold constraints. The idea is to increase the update throttlers to match the update budget. The update throttlers that bring a larger reduction in the update expenditure of the system in return for a smaller reduction in the result accuracy are preferred for increment.

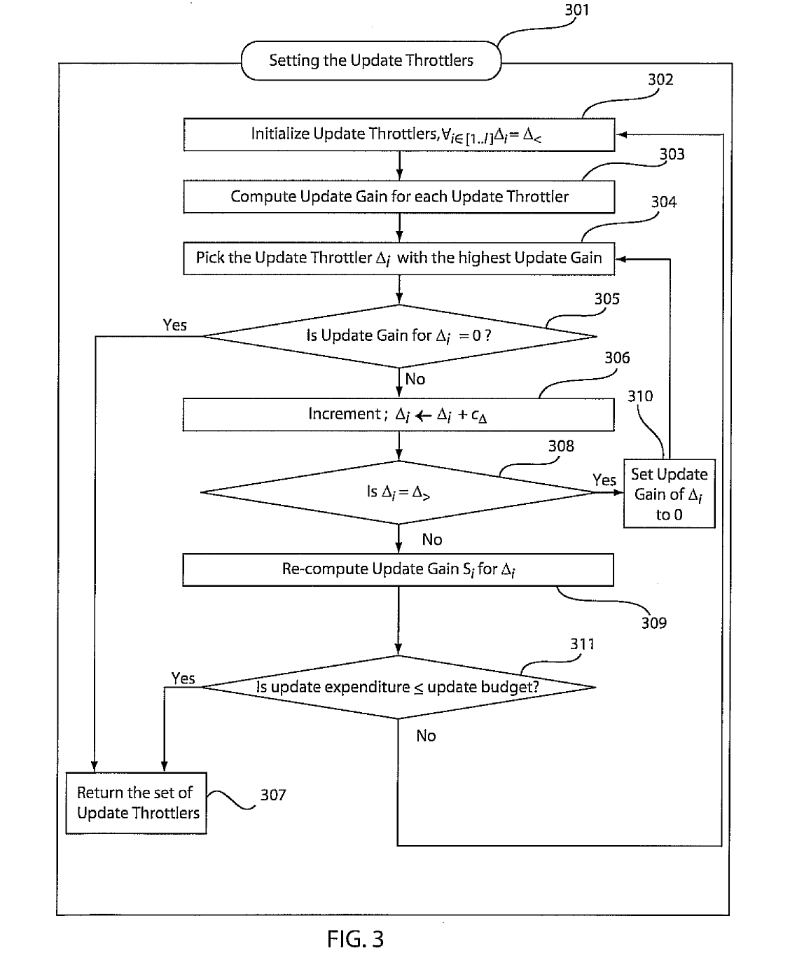

Referring to FIG. 3, a block/flow diagram of a GreedyIncrement algorithm 300 for setting update throttlers is illustratively depicted. The algorithm is a greedy algorithm. The algorithm 301 starts by setting all Δᵢ's to Δ_{<}, the current update expenditure U to n*f(Δ_{<}) and the update budget U_{>} to z*U in block 302. Note that the initial setting is an infeasible solution since the update expenditure is higher than the update budget, that is U>U_{>}. At each greedy step, one of the update throttlers is selected in block 304 (with the highest update gain S) based on the update gain computed in block 303. In block 305, a determination of whether the update gain S is 0 for the selected update throttler is made. If the update throttler is zero the set of update throttlers is returned for use in mobile nodes (109, FIG. 1).

If the update gain for the throttler is not zero in block 305, the update throttler is incremented. The update throttler is increased in block 306, by c_{Δ}, called an increment (or by a smaller value in the case that we undershoot the update budget). When Δᵢ is incremented by c_{Δ} in block 306, the current update expenditure is decreased by nᵢ*(f(Δᵢ)−f(Δᵢ+c_{iΔ})).

In block 308, a check is made as to whether the update throttler Δᵢ equals the maximum value Δ_{>}. If the update throttler equals the maximum, the update gain for Δᵢ is set to zero in block 310 and the algorithm returns to block 304. If update throttler is not equal to the maximum value Δ_{>}, the update gain Sᵢ is recomputed for the incremented update throttler Δᵢ in block 309. This process continues until the current update expenditure decreases to match the update budget in block 311, i.e., U=U_{>}, or all the update throttlers reach their maximum bound in block 305, i.e., ΔᵢΔ₂₂, ∀_{iε[1 . . . l]}. The condition of block 311 implies that the update constraint is satisfied. On the other hand, the condition in block 305 implies that the update budget cannot be met for the given throttle fraction z, leading to the solution Δᵢ=Δ_{>}, ∀_{iε[1 . . . l].}

The GreedyIncrement 301 provides for the selection of the update throttler to use at each greedy step. The update throttler selected is one that has the highest update gain. The update gain may be defined as the ratio of the decrease in update expenditure to the additional inaccuracy introduced in the query results. The rate of decrease in the update expenditure may be denoted at a point Δ by r(Δ), and the rate of decrease can be defined as the negative of the update reduction function f's derivative at point Δ or:

$$r ( Δ ) = - \frac{d ( f ( x ) )}{d x} {\vert}_{x = Δ} \qquad$$

Based on this definition, making a dx increase in Δᵢ will reduce the update expenditure by nᵢ*r(Δᵢ)*dx, and will decrease the query-result inaccuracy by mᵢ*dx. Thus, the update gain for the update throttler Δᵢ, denoted by Sᵢ, is:

Sᵢ(Δ)=(nᵢ/mᵢ)*r(Δ)

In each step of the GreedyIncrement algorithm, an update throttler say, Δⱼ, is selected such that we have j=argmax_{iε[1 . . . l] S}ᵢ(Δᵢ). If the update gain for Δⱼ is larger than the update gain for, say, Δₖ, then increasing Δⱼ provides better update reduction compared to Δₖ for the same amount of increase in query-result inaccuracy.

To provide an optimality guarantee and to guide the setting of c_{Δ}, we approximate the update reduction function f by a non-increasing, piece-wise linear function of κ segments, each of size (Δ_{>}−Δ_{<})/κ. This enables us to prove the following: For c_{Δ}=(Δ_{>}−Δ_{<})/κ, the GreedyIncrement algorithm is optimal for the non-increasing piece-wise linear approximation of the update reduction function f with K segments of size c_{Δ} each. The time complexity of the GreedyIncrement algorithm is given by O(κ*l*logl) or by O(l*logl) if κ is constant. The space complexity is O(l).

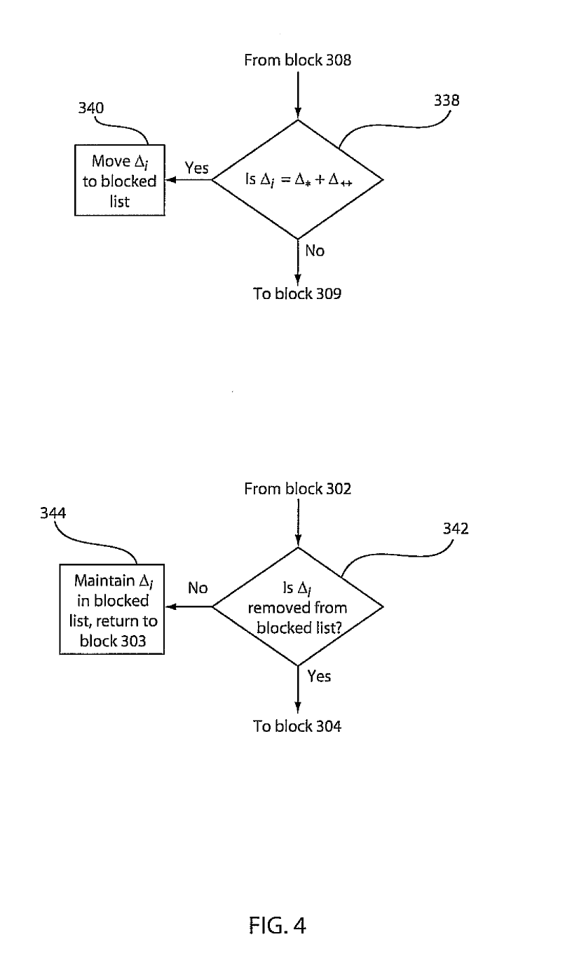

Referring to FIG. 4, to support the fairness constraints dictated by the fairness threshold Δ [symbol] , the following changes to the base algorithm of FIG. 3 may be made. At each greedy step, the update throttler with the highest update gain, say Δᵢ, (from block 304) is incremented by at most c_{Δ}, (in block 306) making sure that it does not go beyond a value that will violate the fairness constraint. For example, if the minimum update throttler is Δ_{*}=min_{jε[1 . . . l]}Δⱼ, then Δᵢ is not increased beyond Δ_{*}+Δ [symbol] . When an update throttler Δᵢ reaches the limit which may be checked in block 338 in FIG. 4, block 338 may follow block 308 or may be substituted for block 30B in FIG. 3. In block 338, if the limit condition is reached, e.g., Δᵢ=Δ_{*}+Δ [symbol] , then the update throttler Δᵢ is moved to a “blocked” list in block 340 and is not considered for the following steps of the algorithm until it is removed from the blocked list in block 342. Otherwise update throttler Δᵢ is maintained in the blocked list in block 344 and not considered. Removal from the blocked list may be provided upon re-initialization or numerous other conditions as the case may be. Whenever the minimum update throttler Δ_{*} is changed, the set of update throttlers in the blocked list that are no longer over the limit are removed and are included in the following steps of the algorithm.

The throttle fraction z can be adaptively adjusted by the load shedder in accordance with the present embodiments, when it is not set as a fixed system-level parameter to retain only a pre-defined fraction of position updates. The adjustment of the throttle fraction is preferably performed by the ThrotLoop algorithm, which observes the position update queue and periodically decides the fraction of position updates that should be retained (throttle fraction z).

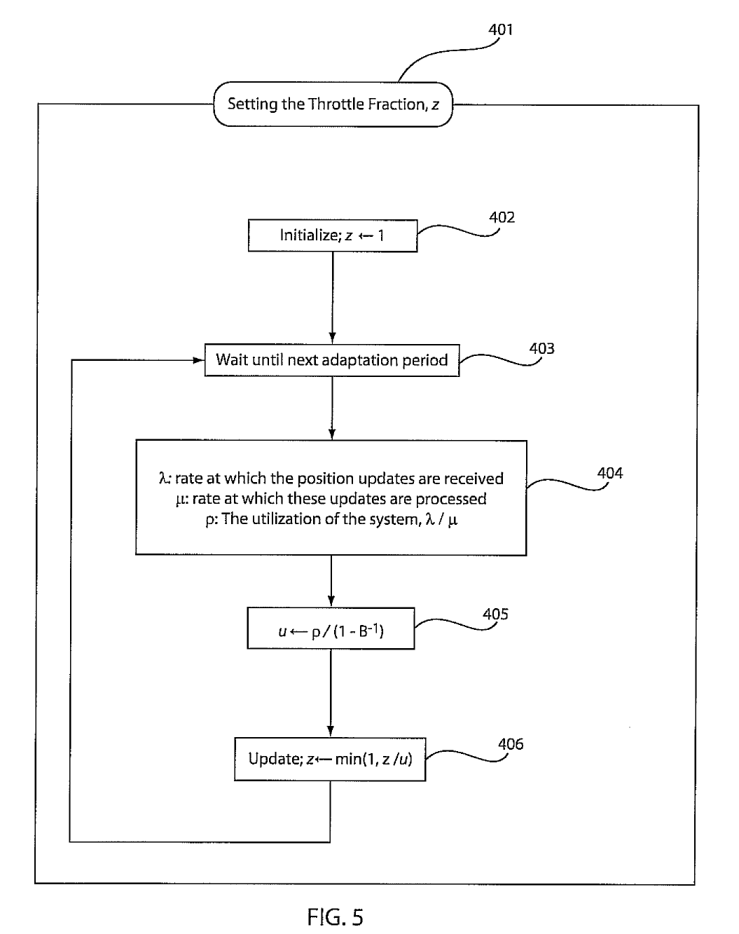

Referring to FIG. 5, a block/flow diagram of a ThrotLoop algorithm 401 is illustratively depicted for setting the throttle fraction. One aspect is to reduce the system load so that the rate at which the position updates are received (λ) and the rate at which these updates are processed (μ) are balanced to prevent dropping updates from the input queue. The utilization of the system, denoted by ρ, is given by λ/μ. Let us denote the maximum size of the input queue by B. Assuming an M/M/1 queuing model, which is known to those skilled in the art, we should have the following relationship between ρ and B to make sure that the average queue length is no more than the maximum queue size: ρ=1−1/B. If the utilization is larger than 1−1/B, it represents an overload situation and thus the throttle fraction z should be decreased. On the other hand, if the utilization is smaller than 1−1/B, it implies that the system is not fully utilized and the throttle fraction z should be increased. This understanding leads to the following procedure that illustratively describes the operation of ThrotLoop.

In block 402, set z to 1. Adaptation periods are provided in block 403. At each adaptation step, determine the current utilization, ρ in block 404. Compare the current utilization, ρ, with the ideal utilization of =1−1/B, by computing u←ρ/(1−1/B) in block 405. Then, update the throttle fraction as: z←min(1, z/u) in block 406.

Those skilled in the art will appreciate that the general approach of dividing a monitoring area into regions and applying various load-shedding amounts in different regions in continual query systems can be applied to the general problem of receiving and processing sensor readings as nodes, where sensors are deployed in a geographically distributed area. The area can be divided into various regions, based on the densities of sensors deployed and the number of continual queries monitoring these sensors. Different amounts of load shedding can be implemented in accordance with how often the sensors in a region send their readings to the query processor. One aspect is to maximize the quality of query results when the available resources cannot receive and process all the sensor readings and some of them must be dropped.

Those skilled in the art will also appreciate that the concept of dividing an area into regions in a geographic space can be applied to an N-attribute domain, where N can be 2 or more, such as temperature and humidity in sensor readings, and the load shedding techniques in mobile CQ systems disclosed in the present invention can be used for load shedding on a data stream processing system. When a data item, like a sensor reading, arrives, it forms a point in the N-attribute domain. A set of continual queries can be defined to monitor various regions in the N-attribute domain. For example, various queries can be defined to monitor sensor readings with different temperatures and humidity levels. The query processor can set different load shedding amounts for processing sensor readings belonging to different regions, aiming to maximize the quality of query results with the available computing and communication resources.

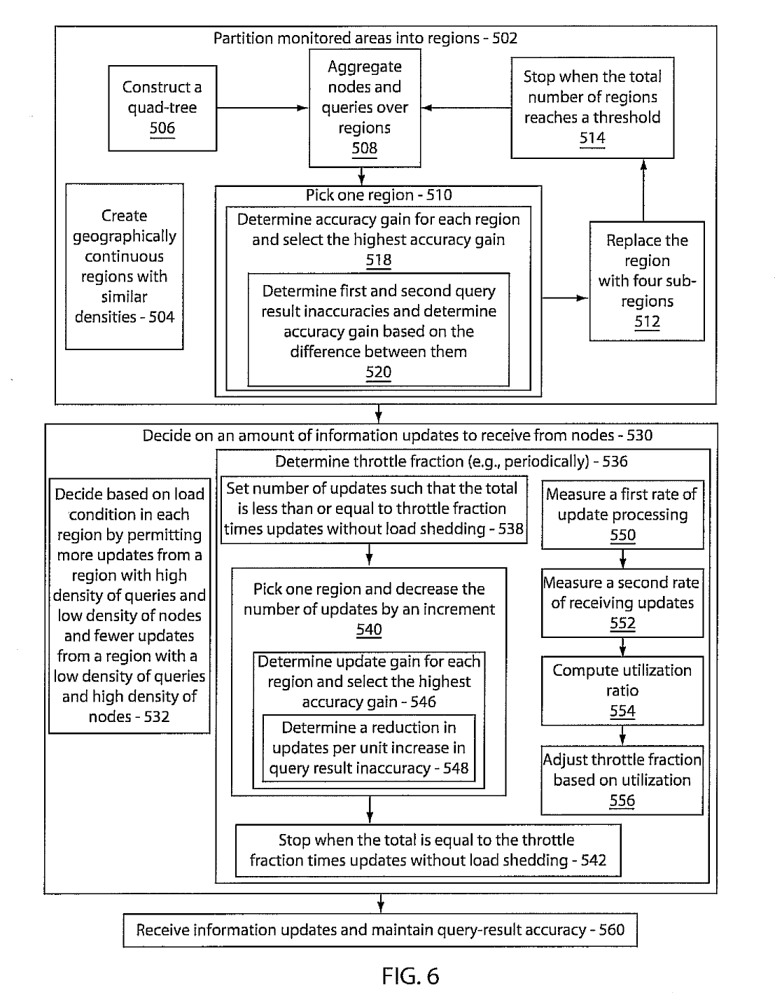

Referring to FIG. 6, a system/method for processing continual queries in a distributed system is illustratively shown. In block 502, an entire monitoring area is partitioned into regions of different size based upon node density. In block 504, partitioning may include creating geographically contiguous regions with similar densities of nodes and continual queries. Partitioning may also include constructing one and more levels of a quad-tree representing regions partitioned over the monitoring area in block 506, aggregating a number of nodes and continual queries over each region in the corresponding quad-tree in block 508, starting from a root of the quad-tree, iteratively picking one region from a current partitioning of the entire monitoring area in block 510 and replacing the one region with the four sub-regions corresponding to four child nodes of the one region in the quad-tree in block 512 and stopping when a total number of regions meets a threshold in block 514.

Picking one region in block 510 may include determining an accuracy gain for each region in the current partitioning and picking a region with the highest accuracy gain in block 518. In block 520, the accuracy gain may be determined by computing a first query result inaccuracy for each region if a same amount of update load shedding is employed for all the nodes in the region to match the number of information updates received from the region to a throttle fraction multiplied by the number of information updates received without update load shedding, computing a second query result inaccuracy for the region if differing amounts of load shedding is employed for the nodes belonging to four sub-regions of the region, to match the number of information updates received from the region to the throttle fraction times the number of information updates received without update load shedding, and computing the accuracy gain as the difference between the first query result inaccuracy and the second query result inaccuracy.

In block 530, an amount of information updates to be received from nodes in the regions is decided based upon load conditions in each region. This decision may include periodically deciding a total amount of information updates to be received based on load conditions in each region. In block 532, the decision includes permitting a greater number of information updates to be received from the nodes in a region with a relatively higher density of queries and a relatively lower density of nodes and permitting fewer information updates to be sent from the nodes in a region with relatively lower density of queries and relatively higher density of nodes.

In block 534, a periodic determination of a throttle fraction is provided, which defines the number of information updates that can be handled by the system, relative to a number of updates generated by the nodes when no load shedding is employed. In block 536, the decision includes setting the number of information updates received from each region such that a total number of information updates received from all regions is equal to or less than the throttle fraction times the number of information updates generated by the nodes when no load shedding is used. In block 538, the decision includes starting with a setting where all updates from all regions are to be received, iteratively picking one region and decreasing the number of information updates to be received from the one region by an increment in block 540 and stopping, in block 542, when the total number of information updates to be received from all regions is equal to the throttle fraction times the number of information updates received without update load shedding.

The step of iteratively picking one region further includes computing an update gain for each region in a current partitioning and picking the region with a highest update gain in block 546. The step of computing of the update gain for a region, further includes determining a reduction in the number of information updates received per unit increase in a query result inaccuracy in block 548.

Periodically setting the throttle fraction may include measuring a first rate at which updates are processed during a prior adaptation period in block 550, measuring a second rate at which updates are received during a prior adaptation period in block 552, computing a utilization as a ratio of the first rate and the second rate in block 554 and adjusting the throttle fraction based on the utilization such that there are no expected drops in a next adaptation period in block 556.

In block 560, information updates are received based on the amount of information updates determined for each region. This can include maintaining query-result accuracy by receiving more information updates from the nodes in some regions than from other regions.

Having described preferred embodiments for load shedding in continual query systems (which are intended to be illustrative and not limiting), it is noted that modifications and variations can be made by persons skilled in the art in light of the above teachings. It is therefore to be understood that changes may be made in the particular embodiments disclosed which are within the scope and spirit of the invention as outlined by the appended claims. Having thus described aspects of the invention, with the details and particularity required by the patent laws, what is claimed and desired protected by Letters Patent is set forth in the appended claims.

What is claimed is:

1. A method for processing continual queries in a distributed system, comprising:
partitioning an entire monitoring area into regions of different size based upon node and query densities;
deciding an amount of information updates to be received from nodes in the regions based upon load conditions in each region; and
receiving information updates based on the amount of information updates determined for each region.

2. The method as recited in claim 1, further comprising maintaining query-result accuracy by receiving more information updates from the nodes in some regions than from other regions.

3. The method as recited in claim 1, wherein deciding includes periodically deciding a total amount of information updates to be received based on load conditions in each region.

4. The method as recited in claim 1, wherein partitioning includes creating geographically contiguous regions with similar densities of nodes and continual queries.

5. The method as recited in claim 1, wherein deciding includes permitting a greater number of information updates to be received from the nodes in a region with a relatively higher density of queries and a relatively lower density of nodes.

6. The method as recited in claim 1, wherein deciding includes permitting fewer information updates to be sent from the nodes in a region with relatively lower density of queries and relatively higher density of nodes.

7. The method as recited in claim 1, wherein deciding includes periodically determining a throttle fraction, which defines the number of information updates that can be handled by the system, relative to a number of updates generated by the nodes when no load shedding is employed.

8. The method as recited in claim 7, wherein deciding includes setting the number of information updates received from each region such that a total number of information updates received from all regions is equal to or less than the throttle fraction times the number of information updates generated by the nodes when no load shedding is used.

9. The method as recited of claim 7, wherein deciding includes:
starting with a setting where all updates from all regions are to be received, iteratively picking one region and decreasing the number of information updates to be received from the one region by an increment; and
stopping when the total number of information updates to be received from all regions is equal to the throttle fraction times the number of information updates received without update load shedding.

10. The method as recited of claim 9, wherein iteratively picking one region includes:
computing an update gain for each region in a current partitioning; and
picking the region with a highest update gain.

11. The method as recited of claim 10, wherein the computing of the update gain for a region, further comprising:
determining a reduction in the number of information updates received per unit increase in a query result inaccuracy.

12. The method as recited of claim 7, wherein periodically setting the throttle fraction includes;
measuring a first rate at which updates are processed during a prior adaptation period;
measuring a second rate at which updates are received during a prior adaptation period;
computing a utilization as a ratio of the first rate and the second rate; and
adjusting the throttle fraction based on the utilization such that there are no expected drops in a next adaptation period.

13. The method as recited in claim 1, wherein partitioning includes:
constructing one and more levels of a tree representing regions partitioned over the monitoring area;
aggregating a number of nodes and continual queries over each region in the corresponding tree;
starting from a root of the tree, iteratively picking one region from a current partitioning of the entire monitoring area and replacing the one region with sub-regions corresponding to child nodes of the one region in the tree; and
stopping when a total number of regions meets a threshold.

14. The method as recited in claim 13, wherein picking one region includes:
determining an accuracy gain for each region in the current partitioning; and
picking a region with the highest accuracy gain.

15. The method as recited in claim 14, wherein determining an accuracy gain includes:
computing a first query result inaccuracy for each region if a same amount of update load shedding is employed for all the nodes in the region to match the number of information updates received from the region to a throttle fraction multiplied by the number of information updates received without update load shedding;
computing a second query result inaccuracy for the region if differing amounts of load shedding is employed for the nodes belonging to four sub-regions of the region, to match the number of information updates received from the region to the throttle fraction times the number of information updates received without update load shedding; and
computing the accuracy gain as the difference between the first query result inaccuracy and the second query result inaccuracy.

16. A computer program product for processing continual queries in a distributed system comprising a computer useable medium including a computer readable program, wherein the computer readable program when executed on a computer causes the computer to perform the steps of:
partitioning an entire monitoring area into regions of different size based upon node density;
deciding an amount of information updates to be received from nodes in the regions based upon load conditions in each region; and
receiving information updates based on the amount of information updates determined for each region.

17. The computer program product as recited in claim 16, wherein deciding includes: permitting a greater number of information updates to be received from the nodes in a region with a relatively higher density of queries and a relatively lower density of nodes, and permitting fewer information updates to be sent from the nodes in a region with relatively lower density of queries and relatively higher density of nodes.

18. The computer program product as recited in claim 16, wherein deciding includes periodically determining a throttle fraction, which defines the number of information updates that can be handled by the system, relative to a number of updates generated by the nodes when no load shedding is employed.

19. The computer program product as recited in claim 16, wherein partitioning includes:
constructing one and more levels of a tree representing regions partitioned over the monitoring area;
aggregating a number of nodes and continual queries over each region in the corresponding tree;
starting from a root of the tree, iteratively picking one region from a current partitioning of the entire monitoring area and replacing the one region with sub-regions corresponding to child nodes of the one region in the tree; and
stopping when a total number of regions meets a threshold.

20. A system for processing continual queries, comprising:
a first layer including a server, the server configured to set a throttle fraction to define a position update budget, compute shedding regions and update throttlers for a given update budget, and report to the shedding regions and the update throttlers to a second layer;
the second layer including a plurality of base stations, each of which receive a subset of the shedding regions and the update throttlers corresponding to the base station's coverage area; and
a third layer including a plurality of mobile nodes which update their location and receive the subset of the shedding regions and the update throttlers corresponding to their region of location.
